(19) United States
(12) Patent Application Publication
(10) Pub. No.: US 2023/0309134 A1
(43) Pub. Date: Sep. 28, 2023

(54) RESOURCE SELECTION COORDINATION FOR NEW RADIO (NR) SIDELINK (SL)

(71) Applicant: Telefonaktiebolaget LM Ericsson (publ), Stockholm (SE)

(72) Inventors: Jose Angel LEON CALVO, AACHEN (DE); Ricardo BLASCO SERRANO, ESPOO (FI); Shehzad Ali ASHRAF, AACHEN (DE)

(21) Appl. No.: 18/004,695

(22) PCT Filed: Jul. 9, 2021
(86) PCT No.: PCT/SE2021/050710

§ 371 Date: Jan. 9, 2023

Related U.S. Application Data
(60) Provisional application No. 63/050,317, filed on Jul. 10, 2020.

(51) Int. Cl. H04W 72/542; H04W 72/563; H04W 72/02

(52) U.S. Cl. CPC H04W 72/542; H04W 72/563; H04W 72/02

(57) ABSTRACT

A method, system, and apparatus are disclosed. In one or more embodiments, a wireless device is provided. The wireless device includes processing circuitry configured to determine whether at least one of a plurality of transmission resources associated with a first wireless device is part of a resource conflict, and cause transmission of resource coordination information that indicates the determination whether the at least one of a plurality of transmission resources associated with the first wireless device is part of the resource conflict.

### FIELD

The present disclosure relates to wireless communications, and in particular, to resource selection coordination in sidelink communications.

### INTRODUCTION

Third Generation Partnership Projection (3GPP) Work on Sidelink Communications

3GPP specified support in Long Term Evolution (LTE, also referred to as fourth Generation (4G)) for proximity services (ProSe). 3GPP Releases 12 and 13 target public safety use cases (e.g., first responders) as well as a small subset of commercial use cases (e.g., discovery). ProSe introduced device-to-device (D2D) communications using the sidelink (SL) interface. As part of 3GPP Release (Rel)-14 and 3GPP Rel-15, changes were introduced to the LTE SL framework with the aim of supporting V2X communications, where V2X (vehicle-to-everything or vehicle-to-anything) collectively denotes communication between a vehicle to any other endpoint (e.g., a vehicle, a pedestrian, etc.). The feature targeted mostly basic V2X use cases such as day-1 safety, etc.

3GPP Rel-16 is developing specifications for the sidelink interface for the 5th Generation (5G) also referred to as New Radio (NR). The NR sidelink in 3GPP Rel-16 targets advanced V2X services, which can be categorized into four use case groups: vehicles platooning, extended sensors, advanced driving and remote driving. The advanced V2X services may require a new sidelink in order to meet the stringent requirements in terms of latency and reliability. The NR sidelink is designed to provide higher system capacity and better coverage, and to allow for an extension to support the future development of further advanced V2X services and other related services.

Given the targeted V2X services by NR sidelink, it may be recognized that groupcast/multicast and unicast transmissions may be desired, in which the intended receiver of a message consists of only a subset of the vehicles in proximity to the transmitter (groupcast) or of a single vehicle (unicast). For example, in the platooning service, there are certain messages that are only of interest to the members of the platoon, making the members of the platoon a natural groupcast. In another example, the see-through use case may involve only a pair of vehicles, for which unicast transmissions fits. Therefore, NR sidelink not only supports broadcast as in the LTE sidelink, but also groupcast and unicast transmissions. Like in the LTE sidelink, the NR sidelink is designed in such a way that its operation is possible with and without network coverage, and with varying degrees of interaction between the wireless devices and network nodes including support for standalone, network-less operation.

In 3GPP Rel-17, the 3GPP is working on multiple enhancements for the sidelink with the aim of extending the support for V2X and to cover other use cases (UCs) such as public safety. Among these, improving the performance of power limited wireless devices (e.g., pedestrian wireless devices, first responder wireless devices, etc.) and improving the performance using resource coordination may be considered critical.

Resource Allocation for Sidelink Transmissions

Similar to the LTE sidelink, there are two resource allocation modes for NR sidelink:
Network-based resource allocation, in which the network node selects the resources and other transmit parameters used by sidelink wireless devices. In some cases, the network node may control every single transmission parameter. In other cases, the network node may select the resources used for transmission but may give the transmitter, i.e., wireless device, the freedom to select some of the transmission parameters, possibly with some restrictions. In the context of NR SL, 3GPP refers to this resource allocation mode as Mode 1.
Autonomous resource allocation, in which the wireless devices autonomously select the resources and other transmit parameters. In this mode, there may be no intervention by the network node (e.g., out of coverage, unlicensed carriers without a network deployment, etc.) or very minimal intervention by the network node (e.g., configuration of pools of resources, etc.). In the context of NR SL, 3GPP refers to this resource allocation mode as Mode 2.

Mode 2 in NR SL

In SL transmission mode 2, distributed resource selection is employed, i.e., there is no central node, i.e., network node, for scheduling and wireless devices play the same role in autonomous resource selection. Transmission Mode 2 is based on two functionalities: reservation of future resources and sensing-based resource allocation. Reservation of future resources is performed so that the wireless device sending a message also notifies the receivers about its intention to transmit using certain time-frequency resources at a later point in time. For example, a wireless device transmitting at time T informs the receivers, i.e., wireless devices to receive the transmission, that it will transmit using the same frequency resources at time T+100 MS.

Resource reservation allows a wireless device to predict the utilization of the radio resources in the future. That is, by listening to the current transmissions of another wireless device, it also obtains information about potential future transmissions. This information can be used by the wireless device to avoid collisions when selecting its own resources. Specifically, a wireless device predicts the future utilization of the radio resources by reading received booking messages and then schedules its current transmission to avoid using the same resources. This is known as sensing-based resource selection.

The sensing-based resource selection scheme specified in NR 3GPP Rel-16 can be generally summarized in the following steps and is defined in the 3GPP Technical Specification (TS) 38.214 (v16.1.0).
A wireless device senses the transmission medium during an interval [n-a, n-b], where n is a time reference, and a>b≥0 define the duration of the sensing window. The length of the sensing window is (pre-)configurable.
Based on the sensing results, the wireless device predicts the future utilization of the transmission medium at a future time interval [n+T1, n+T2], where T2>T1≥0. The interval [n+T1, n+T2] is the resource selection window.
The wireless device selects one or more time-frequency resources among the resources in the selection window [n+T1, n+T2] that are predicted/determined to be selectable (e.g., idle, usable, available, etc.).

Clause 8.1.4 of 3GPP release 16, which is described below, relates to sensing and selection windows. More specifically relates to:
The sensing window that is explicitly defined in Step 2.
The resource selection window that corresponds to the time interval [n+T₁, n+T₂], as described in Step 1.

8.1.4 of 3GPP Release 16—Wireless device procedure for determining the subset of resources to be reported to higher layers in physical sideline shared channel (PSSCH) resource selection in sidelink resource allocation mode 2

In resource allocation mode 2, the higher layer can request the wireless device to determine a subset of resources from which the higher layer may select resources for PSSCH/physical sidelink control channel (PSCCH) transmission. To trigger this procedure, in slot n, the higher layer provides the following parameters for this PSSCH/PSCCH transmission:
the resource pool from which the resources are to be reported;
L1 priority, prio_{TX};
the remaining packet delay budget;
the number of sub-channels to be used for the PSSCH/PSCCH transmission in a slot, L_{subCH};
optionally, the resource reservation interval, P_{rsvp_TX}, in units of ms.

The following higher layer parameters affect this procedure:
t2min_SelectionWindow: internal parameter T₂ₘᵢₙ is set to the corresponding value from higher layer parameter t2 min_SelectionWindow for the given value of prio_{TX}.
SL-ThresRSRP_pi_pj: this higher layer parameter provides an RSRP threshold for each combination (pᵢ, pⱼ), where pᵢ is the value of the priority field in a received SCI format 0-1 and pᵢ is the priority of the transmission of the wireless device selecting resources; for a given invocation of this procedure, pⱼ=prio_{TX}.
RSforSensing selects if the wireless device uses the PSSCH-RSRP (e.g., reference signal received power) or PSCCH-RSRP measurement, as defined in clause 8.4.2.1 of 3GPP Release 16.
reservationPeriodAllowed
t0_SensingWindow: internal parameter T₀ is defined as the number of slots corresponding to t0_SensingWindow ms.

The resource reservation interval, P_{rsvp_TX} if provided, is converted from units of ms to units of logical slots, resulting in P′_{rsvp_TX}.

Notation:

(t₀^{SL}, t₁^{SL}, t₂^{SL}, . . . ) denotes the set of slots which can belong to a sidelink resource pool.

The following steps are used:

Step 1) A candidate single-slot resource for transmission R_{x,y} is defined as a set of L_{subcH} contiguous sub-channels with sub-channel x+j in slot t_{y}^{SL} where j=0, . . . , L_{subCH}−1. The wireless device may assume that any set of L_{subCH} contiguous sub-channels included in the corresponding resource pool within the time interval [n+T₁, n+T₂] correspond to one candidate single-slot resource, where
selection of T₁ is up to wireless device implementation under 0≤T₁≤T_{proc,1}, where T_{proc,1} is TBD;
if T₂ₘᵢₙ is shorter than the remaining packet delay budget (in slots) then T₂ is up to wireless device implementation subject to T₂ₘᵢₙ≤T₂≤remaining packet budget (in slots); otherwise T₂ is set to the remaining packet delay budget (in slots).

The total number of candidate single-slot resources is denoted by Mₜₒₜₐₗ.

Step 2) The sensing window is defined by the range of slots [n—T₀, n— T_{proc,0}) where T₀ is defined above and T_{proc,1} is to be determined. The wireless device may monitor slots which can belong to a sidelink resource pool within the sensing window except for those in which its own transmissions occur. The wireless device may perform the behaviour in the following steps based on PSCCH decoded and RSRP measured in these slots.

Step 3) The internal parameter Th(pᵢ) is set to the corresponding value from higher layer parameter SL-ThresRSRP_pi_pj for pⱼ equal to the given value of prio_{TX} and each priority value pᵢ.

Step 4) The set S_{A} is initialized to the set of all the candidate single-slot resources.

Step 5) The wireless device may exclude any candidate single-slot resource R_{x,y} from the set S_{A} if it meets all the following conditions:
the wireless device has not monitored slot tₘ^{SL} in Step 2.
for any periodicity value allowed by the higher layer parameter reservationPeriodAllowed and a hypothetical SCI format 0-1 received in slot tₘ^{SL} with “Resource reservation period” field set to that periodicity value and indicating all subchannels of the resource pool in this slot, condition c in step 6 would be met.

Step 6) The wireless device may exclude any candidate single-slot resource R_{x,y} from the set S_{A} if it meets all the following conditions:
a) the wireless device receives an SCI format 0-1 in slot tₘ^{SL}, and “Resource reservation period” field, if present, and “Priority” field in the received SCI format 0-1 indicate the values P_{rsvp_RX} and prio_{RX}, respectively;
b) the RSRP measurement performed, according to clause 8.4.2.1 of 3GPP Release 16 for the received SCI format 0-1, is higher than Th(prio_{RX});
c) the SCI format received in slot tₘ^{SL} the same SCI format which, if and only if the “Resource reservation period” field is present in the received SCI format 0-1, is assumed to be received in slot(s) t_{m+q×P′}_{_{rsvp_RX}}^{SL} determines the set of resource blocks and slots which overlaps with R_{x,y+j×P′}_{_{rsvp_TX}}^{SL}=1, 2, . . . , Q and j=0, 1, . . . , Cᵣₑₛₑₗ−1. Here, P′_{rsvp_RX} is P_{rsvp_RX} converted to units of logical slots,

$$Q = ⌈ \frac{{T}_{scal}}{{P}_{rsvp \_ Rx}} ⌉$$

if P_{rsvp_RX}<T_{scal} and n′−m≤P′_{rsvp_RX}, where t_{n′}^{SL}=n if slot n belongs to the set (t₀^{SL}, t₁^{SL}, . . . , t_{T}_{ₘₐₓ}^{SL}) otherwise slot t_{n′}^{SL} is the first slot after slot n belonging to the set (t₀^{SL}, t₁^{SL}, . . . , t_{T}_{ₘₐₓ}^{SL}) otherwise Q=1. T_{scal} is for further study.

Step 7) If the number of candidate single-slot resources remaining in the set S_{A} is smaller than 0.2·Mₜₒₜₐₗ, then Th(pᵢ) is increased by 3 dB for each priority value Th(pᵢ) and the procedure continues with step 4.

The wireless device may report set S_{A} to higher layers.

Re-Evaluation and Pre-Emption Mechanism in Mode 2

Furthermore, in NR SL for Mode 2, re-evaluation and pre-emption mechanisms are also supported. According to the re-evaluation mechanism, a wireless device before performing the announcing the reservation of (a) particular resource(s) for its transmission(s) re-evaluates the candidate set of resources again. The purpose of such procedure is to evaluate if the earlier selected resource(s) are still suitable for transmission or not. If a wireless device determines that the earlier selected resource(s) is (are) not suitable for its own transmission anymore (e.g., some other wireless device also selected the same resource in the meantime), it triggers the resource selection mechanism again. Meaning, a new set of candidate resources is created, and the resource(s) is(are) randomly selected from the newly created candidate resource set.

Similarly, according to the pre-emption mechanism, a wireless device (re-) triggers the resource selection if another wireless device with higher priority selects the same resource for its transmission. In this case, a wireless device with low priority transmission (re-)triggers resource selection and a new set of candidate resource set is created/determined by the wireless device based on the recent sensing information.

Configuration, Pre-Configuration, and Predefinition of Parameters

To operate sidelink, different parameters may be used. These parameters may be provided to a wireless device in different ways:
The parameters may be configured by a network node (e.g., a gNB). Configuration may be received using dedicated or broadcast signaling, for example using a SIB or RRC signaling. This is typically used when the wireless device is in coverage of a network node for a given frequency.
The parameters may be preconfigured in the wireless device. In this case, the pre-configuration is stored in the wireless device, typically in the SIM card. This is typically used when the wireless device is not in coverage for a given frequency.
The parameters may be predefined or defined in a specification.

Physical Sidelink Channels

In NR SL, different physical sidelink channels are defined.
Physical sidelink control channel (PSCCH): This is used to carry (part of) sidelink control information (SCI), which is also termed as 1st stage SCI. 1st stage SCI carries the resource allocation information which is used to decode for performing sensing-based resource allocation (i.e., mode-2)
Physical sidelink shared channel (PSSCH): This is used to carry actual data transmission. Also, a part of SCI, also termed as 2nd stage SCI, is carried over PSSCH.
Physical sidelink feedback channel (PSFCH): This is used to carry the HARQ feedback information such as HARQ-ACK or HARQ-NACK. In 3GPP Rel. 16, only sequence based PSFCH is supported.
Physical sidelink broadcast channel (PSBCH): This is used to carry the system information which is used to perform sidelink transmissions.

As described above, the procedures performed by wireless devices for sidelink resource allocation (Mode 2) may require the wireless devices to perform a sensing mechanism in order to find feasible or available resources to transmit. However, due to the distributed architecture of device-to-device communication, persistent collisions between a pair (or group) of wireless device could happen and under some circumstances, none of the wireless devices involved in the communication may be aware of it. For example, if two or more wireless devices perform resource selection exactly at the same time, then they have no knowledge of the resources selected by each other and collisions may occur among these wireless devices. Another example could be that the wireless devices are unable to decode the sidelink control information (SCI), i.e., they are hidden to each other, and therefore, they have no information about the resources reserved/selected by the rest of wireless devices.

In these cases, a pair of wireless devices (or several wireless devices) could choose the same set of resources at the same time for (a set of) transmission(s), and therefore, the wireless devices do not know about this collision, i.e., no pre-emption or re-evaluation mechanism is triggered/applied. This is because there is no collision detection mechanism (i.e., one wireless device cannot detect/sense the transmission from another wireless device) either due to half-duplex (i.e., the wireless device is transmitting itself and cannot receive) or due to hidden wireless devices (i.e., a wireless device is out-of-coverage of the other wireless device selecting the same resource).

Additionally, it could be possible that a wireless device does not gather all the necessary information during its own sensing phase, i.e., the wireless device performs partial sensing (i.e. a reduced sensing window is used to determine the candidate resources for transmission). In this case, a wireless device may not be able to detect all the occupied/reserved resources due to limited/partial sensing and may experience a high probability of collision if the legacy resource selection mechanism is followed.

### SUMMARY

Some embodiments advantageously provide methods, systems, and apparatuses for resource selection coordination in sidelink communications.

According to one or more embodiments, a wireless device receives a resource coordination message (with or without previously sending an enquiry message) to boost/improve its own resource selection. Based on the resource coordination message, the wireless device then performs resource (re)selection. That is, considering the information a wireless device receives in the coordination message, it selects the (optimum) resource(s) for its own transmission. In case the wireless device has already selected the resource(s), it may either keep the same resource(s) as selected previously in case it is (they are) still considered suitable for transmission or selects another resource(s) in case the earlier selected resource(s) is (are) not suitable for transmission based on the received coordination message.

Moreover, the coordination message may include one of a set of resources (e.g., a resource map indicating suitable/unsuitable resources) and a flag (e.g., one-bit signal) indicating the wireless device to perform a re-selection of the resources selected for transmission.

One or more embodiments described herein provide one or more of the following advantages:
Improve the likelihood of a collision-free resource selection by a wireless device.
Persistent resource collisions which cannot be solved by the current re-evaluation and pre-emption mechanisms can be reduced or completely solved using the resource coordination message.
Improve the performance by reducing the collision probability in case of wireless device(s) performing partial sensing.

According to one aspect of the disclosure, a wireless device is provided. The wireless device include processing circuitry configured to determine whether at least one of a plurality of transmission resources associated with a first wireless device is part of a resource conflict, and cause transmission of resource coordination information that indicates the determination whether the at least one of a plurality of transmission resources associated with the first wireless device is part of the resource conflict.

According to one or more embodiments of this aspect, the processing circuitry is further configured to trigger the transmission of the resource coordination information based at least on sensed information determined by the wireless device. According to one or more embodiments of this aspect, the processing circuitry is further configured to trigger the transmission of the resource coordination information based at least on sensed information received from a second wireless device. According to one or more embodiments of this aspect, the processing circuitry is further configured to trigger the transmission of the resource coordination information based at least on the determination that the resource conflict exists where the resource conflict corresponds to a resource collision of one of the plurality of transmission resources with at least one other transmission resource associated with another wireless device other than the first wireless device.

According to one or more embodiments of this aspect, the processing circuitry is further configured to trigger the transmission of the resource coordination information based at least on a distance between the first wireless device and the wireless device. According to one or more embodiments of this aspect, the resource coordination information includes information received from a second wireless device. According to one or more embodiments of this aspect, the resource coordination information includes a bitmap of resources indicating whether each one of the resources are one of available and unavailable.

According to one or more embodiments of this aspect, the resource coordination information includes a bitmap of resources that are indicated as one of: for the first wireless device to use; and available for use. According to one or more embodiments of this aspect, the indication of the determination whether the at least one of the plurality of transmission resources associated with the first wireless device is part of the resource conflict is provided by a one bit field of the resource coordination information. According to one or more embodiments of this aspect, the indication of the determination whether the at least one of the plurality of transmission resources associated with the first wireless device is part of the resource conflict is provided by sequence.

According to one or more embodiments of this aspect, the indication of the determination whether the at least one of a plurality of transmission resources associated with the first wireless device is part of the resource conflict is an implicit indication. According to one or more embodiments of this aspect, the processing circuitry is further configured to receive an enquiry message for requesting resource coordination, the resource coordination information being transmitted at least in response to the enquiry message. According to one or more embodiments of this aspect, the enquiry message is based at least on one of a detected channel condition, a pre-emption procedure and a Hybrid Automatic Repeat Request, HARQ, procedure.

According to one or more embodiments of this aspect, the enquiry message is received via a physical layer signaling. According to one or more embodiments of this aspect, the enquiry message is received via one of a medium access control, MAC, control element, CE, and radio resource control, RRC, message. According to one or more embodiments of this aspect, the enquiry message indicates at least one of: a preferred format of the resource coordination information; a priority of a transmission on the plurality of transmission resources associated with the enquiry message; a number of subchannels for a transmission on the plurality of transmission resources; and an expected time for receiving the resource coordination information.

According to one or more embodiments of this aspect, the resource conflict corresponds to at least one predicted collision in reserved resources that include at least the plurality of transmission resources. According to one or more embodiments of this aspect, the resource conflict corresponds to at least one collision that occurred in resources that include at least the plurality of transmission resources. According to one or more embodiments of this aspect, the collision corresponds to transmission on the same resources in at least one of time and frequency.

According to one or more embodiments of this aspect, the collision occurs during half-duplex communications. According to one or more embodiments of this aspect, the plurality of transmission resources associated with the first wireless device corresponds to resources at least one of resource for transmission and used for transmission. According to one or more embodiments of this aspect, the resource coordination information is transmitted via one of a medium access control, MAC, control element, CE, radio resource control, RRC, message and physical layer signaling.

According to another aspect of the disclosure, a first wireless device is provided. The first wireless device includes processing circuitry configured to receive a resource coordination information where the resource coordination information indicates whether at least one of a plurality of transmission resources associated with the first wireless device is part of the resource conflict, and select resources for transmission based at least on the resource coordination information.

According to one or more embodiments of this aspect, the resource coordination information indicates that the resource conflict exists where the resource conflict corresponds to at least one collision that occurred in resources that include at least the plurality of transmission resources. According to one or more embodiments of this aspect, the resource information indicates that the resource conflict exists where the resource conflict corresponds to at least one predicted collision in reserved resources that include at least the plurality of transmission resources. According to one or more embodiments of this aspect, the resource coordination information is based at least on sensed information received from a second wireless device.

According to one or more embodiments of this aspect, the resource coordination information includes a bitmap of resources indicating whether each one of the resources are one of available and unavailable. According to one or more embodiments of this aspect, the resource coordination information includes a bitmap of resources that are indicated as one of: for the first wireless device to use, and available for use. According to one or more embodiments of this aspect, the processing circuitry is further configured to: receive additional resource coordination information including an additional bitmap; and determine an updated set of resources resulting from the bitmap and the additional bitmap where the selected resources for transmission is selected based at least on the updated set of resources.

According to one or more embodiments of this aspect, the updated set of resources corresponds to one of: resources that are indicated as being available in the bitmap and the additional bitmap; resources having a priority level one of equal to and less than a priority level associated with the plurality of transmission resources; and resources associated with at least one more recent timestamp than the remaining resources indicated in the bitmap and additional bitmap. According to one or more embodiments of this aspect, the indication of whether the at least one of the plurality of transmission resources associated with the first wireless device is part of the resource conflict is provided by a one bit field of the resource coordination information. According to one or more embodiments of this aspect, the indication of whether the at least one of the plurality of transmission resources associated with the first wireless device is part of the resources conflict is provided by a sequence.

According to one or more embodiments of this aspect, the indication of whether the at least one of the plurality of transmission resources associated with the first wireless device is part of the resources conflict is an implicit indication. According to one or more embodiments of this aspect, the selection of resources for transmission is part of a re-selection procedure triggered by the resource coordination information. According to one or more embodiments of this aspect, the processing circuitry is further configured to transmit an enquiry message for requesting resource coordination where the receiving of the resource coordination information is in response to at least the enquiry message.

According to one or more embodiments of this aspect, the transmission of the enquiry message is in response to at least on one of a detected channel condition, a pre-emption procedure and a Hybrid Automatic Repeat Request, HARQ, procedure. According to one or more embodiments of this aspect, the enquiry message is transmitted via a physical layer signaling. According to one or more embodiments of this aspect, the enquiry message is transmitted via one of a medium access control, MAC, control element, CE, and radio resource control, RRC, message.

According to one or more embodiments of this aspect, the enquiry message indicates at least one of: a preferred format of the resource coordination information; a priority of a transmission on the plurality of transmission resources associated with the enquiry message; a number of subchannels for a transmission on the plurality of transmission resources; and an expected time for receiving the resource coordination information. According to one or more embodiments of this aspect, the processing circuitry is further configured to sense information associated with the plurality of transmission resources where the selection of the resources for transmission is further based on the sensed information associated with the plurality of transmission resources. According to one or more embodiments of this aspect, the processing circuitry is further configured to merge the sensed information associated with the plurality of transmission resources with information included in the resource coordination information.

According to one or more embodiments of this aspect, the resource conflict corresponds to at least one predicted collision in reserved resources that include at least the plurality of transmission resources. According to one or more embodiments of this aspect, the resource conflict corresponds to a collision that occurred in resources that include at least the plurality of transmission resources. According to one or more embodiments of this aspect, the collision corresponds to transmission on the same resources in at least one of time and frequency.

According to one or more embodiments of this aspect, the collision occurs during half-duplex communications. According to one or more embodiments of this aspect, the plurality of transmission resources associated with the first wireless device corresponds to resources at least one of resource for transmission and used for transmission. According to one or more embodiments of this aspect, the resource coordination information is transmitted via one of a medium access control, MAC, control element, CE, radio resource control, RRC, message and physical layer signaling.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example system according to the principles in the present disclosure;

FIG. 2 is a block diagram of wireless devices according to some embodiments of the present disclosure;

FIG. 3 is a flowchart of an example process in a wireless device according to some embodiments of the present disclosure;

FIG. 4 is a flowchart of another example process in a wireless device according to some embodiments of the present disclosure;

FIG. 5 is a flowchart of yet another example process in a wireless device according to some embodiments of the present disclosure;

FIG. 6 is a flowchart of yet another example process in a wireless device according to some embodiments of the present disclosure;

FIG. 7 is a signaling diagram of an example process according to some embodiments of the present disclosure; and

FIG. 8 is a signaling diagram of example process of step 0 according to some embodiments of the present disclosure.

### DETAILED DESCRIPTION

One or more embodiments described in the disclosure relate to an arrangement for resource selection coordination between wireless devices using NR sidelink (SL) communication. The arrangement is based on, for example, a message such as an enquiry message where one of the wireless devices involved in the communication requests a resource coordination message to help with its own resource selection decision. While the disclosure is described in terms of 3GPP technology (NR SL) and terminology, one or more of the embodiments described herein may be equally applicable to any kind of direct communications between wireless devices involving device-to-device (D2D) communications such as LTE SL or other Institute of Electrical and Electronic Engineers (IEEE) based technologies.

One or more embodiments described herein relate to operations and methods using resource allocation Mode 2 or any other mode in which the wireless device(s) perform sensing and resource allocation.

Before describing in detail exemplary embodiments, it is noted that the embodiments reside primarily in combinations of apparatus components and processing steps related to resource selection coordination in sidelink communications. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

An indication generally may explicitly and/or implicitly indicate the information it represents and/or indicates. Implicit indication may for example be based on information from which the indication can be derived. Explicit indication may for example be based on a parametrization with one or more parameters, and/or one or more index or indices, and/or one or more bit patterns representing the information.

Transmitting in the downlink may pertain to transmission from the network or network node to the wireless device. Transmitting in the uplink may pertain to transmission from the wireless device to the network or network node. Transmitting in sidelink may pertain to (direct) transmission from one wireless device to another. Uplink, downlink and sidelink (e.g., sidelink transmission and reception) may be considered communication directions.

As used herein, the term (pre-)configuration includes any of configuration and pre-configuration.

Note further, that functions described herein as being performed by a wireless device be distributed over a plurality of wireless devices. In other words, it is contemplated that the functions of the wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments provide resource selection coordination in sidelink communications.

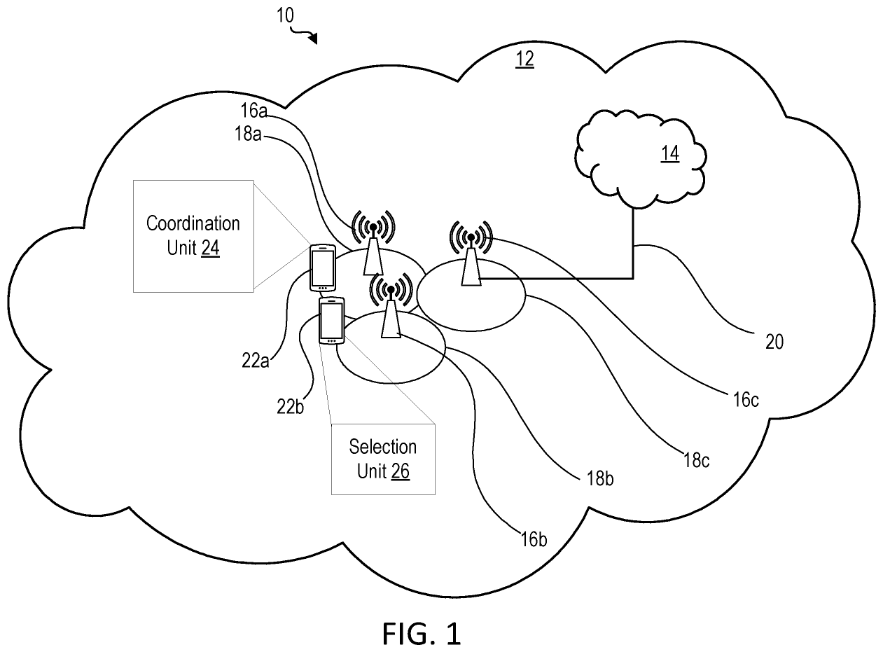

Referring now to the drawing figures, in which like elements are referred to by like reference numerals, there is shown in FIG. 1 a block diagram of an example system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a may be configured to wirelessly connect to, or be paged by, the corresponding network node 16a. A second WD 22b in coverage area 18a may be wirelessly connectable to the corresponding network node 16a. However, in one or more embodiments, one or more wireless devices such as wireless device 22a and 22b may be configured to perform sidelink communication, which may not involve decisions performed by network node 16, i.e., wireless devices 22 may communicate with each other independent of the network node 16. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A wireless device 22 is configured to include a coordination unit 24 which is configured to perform one or more wireless device 22 functions as described herein such as with respect to resource selection coordination in sidelink communications. For example, coordination unit 24 may be configured to perform one or more of processes performed by, for example, wireless device 22a such as step 2, as described below. A wireless device 22 is configured to include a selection unit 26 which is configured to perform one or more wireless device 22 functions as described herein such as with respect to resource selection coordination in sidelink communications. For example, selection unit 26 may be configured to perform one or more processes performed by, for example, wireless device 22b such as steps 1, 3 and 4, as described below. In one or more embodiments, while wireless device 22 may include both coordination unit 24 and selection unit 26, the wireless device 22 (e.g., wireless device 22a) may perform processes of one unit (e.g., coordination unit 24) while another wireless device 22 (e.g., wireless device 22b) performs processes of the other unit (e.g., selection unit 26).

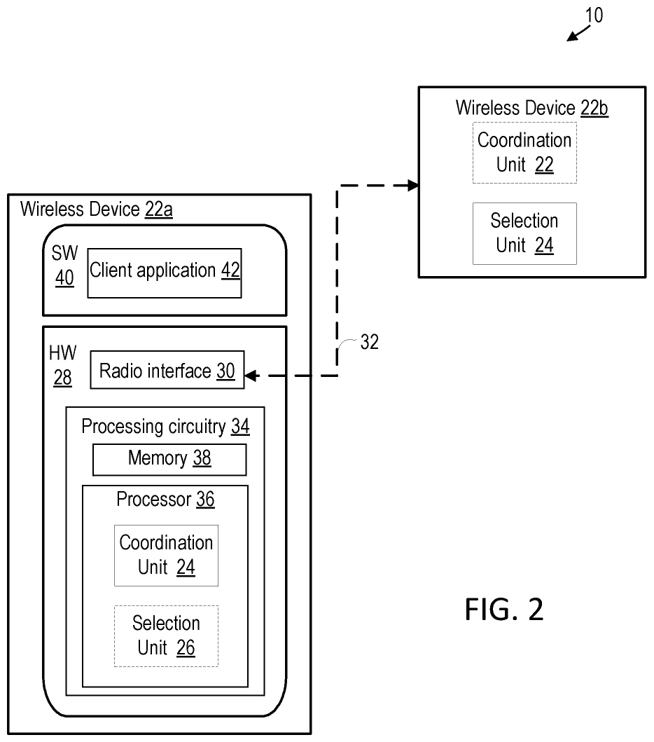

Example implementations, in accordance with an embodiment, of wireless device 22a and 22b, discussed in the preceding paragraphs will now be described with reference to FIG. 2. Wireless device 22a may have hardware 28 that may include a radio interface 30 configured to set up and maintain a wireless connection 32 with a network node 16 serving a coverage area 18 in which the WD 22 is currently located and/or another wireless device 22 such as via sidelink communication. The radio interface 30 may be formed as or may include, for example, one or more RF transmitters, one or more RF receivers, and/or one or more RF transceivers.

The hardware 28 of the WD 22 further includes processing circuitry 34. The processing circuitry 34 may include a processor 36 and memory 38. In particular, in addition to or instead of a processor, such as a central processing unit, and memory, the processing circuitry 34 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 36 may be configured to access (e.g., write to and/or read from) memory 38, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 40, which is stored in, for example, memory 38 at the WD 22, or stored in external memory (e.g., database, storage array, network storage device, etc.) accessible by the WD 22. The software may be executable by the processing circuitry 34. The software 40 may include a client application 42. The client application 42 may interact with the user to generate the user data that it provides.

The processing circuitry 34 may be configured to control any of the methods and/or processes described herein and/or to cause such methods, and/or processes to be performed, e.g., by WD 22. The processor 36 corresponds to one or more processors 36 for performing WD 22 functions described herein. The WD 22 includes memory 38 that is configured to store data, programmatic software code and/or other information described herein. In some embodiments, the software 40 and/or the client application 42 may include instructions that, when executed by the processor 36 and/or processing circuitry 34, causes the processor 36 and/or processing circuitry 34 to perform the processes described herein with respect to WD 22. For example, the processing circuitry 34 of the wireless device 22 may include a coordination unit 24 configured to perform one or more wireless device 22 functions as described herein such as with respect to resource selection coordination in sidelink communications. The processing circuitry 34 may also include selection unit 26 configured to perform one or more wireless device 22 functions such as with respect to resource selection coordination in sidelink communications.

In some embodiments, the inner workings of the wireless device 22 may be as shown in FIG. 2 and independently, the surrounding network topology may be that of FIG. 1.

Although FIGS. 1 and 2 show various “units” such as coordination unit 24 and selection unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry. In one or more embodiments and/or examples described below, wireless device 22a is configured with coordination unit 24 while wireless device 22b is configured with selection unit 26.

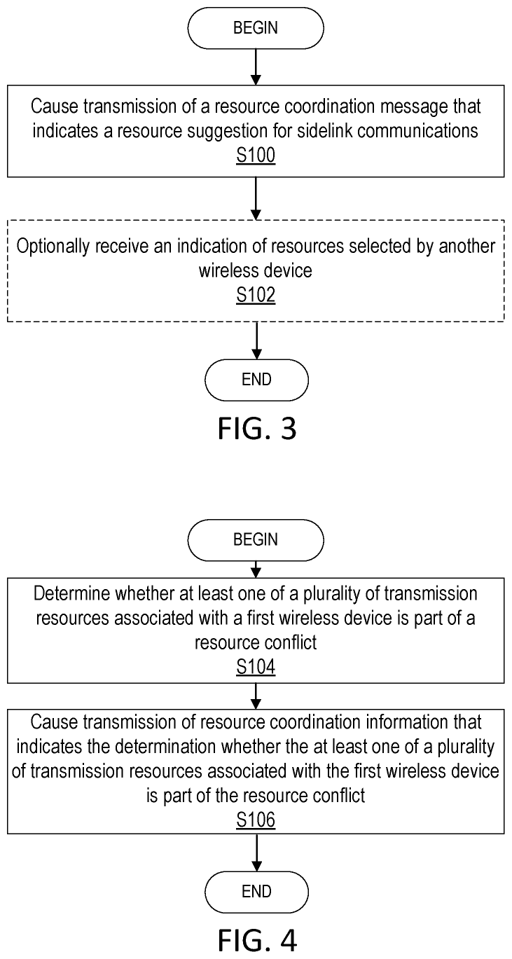

FIG. 3 is a flowchart of an example process in a wireless device 22 (e.g., wireless device 22a) according to some embodiments of the present disclosure. One or more Blocks and/or functions performed by wireless device 22 may be performed by one or more elements of wireless device 22 such as by coordination unit 24 in processing circuitry 34, processor 36, radio interface 30, etc. In one or more embodiments, wireless device 22 such as via one or more of processing circuitry 34, processor 36, coordination unit 24 and radio interface 30 is configured to cause (Block S100) transmission of a resource coordination message (e.g., resource coordination information) that indicates a resource suggestion for sidelink communications, as described herein. In one or more embodiments, wireless device 22 such as via one or more of processing circuitry 34, processor 36, coordination unit 24 and radio interface 30 is configured to optionally 7 receive (Block S102) an indication of resources selected by another wireless device 22, as described herein.

According to one or more embodiments, the resource coordination message is one of a map-based resource coordination message and a one-bit resource coordination message. According to one or more embodiments, the map-based resource coordination message indicates at least one of: a bitmap of resources indicating at least one of scheduled and idle resources; a RSRP mapping; a percentage of collisions, and signals received in a predefined set of resources. According to one or more embodiments, the one-bit resource coordination message indicates one of: to trigger resource (re)-selection; and an acknowledgement and negative acknowledgement. In one or more embodiments, scheduled resources (e.g., occupied resources) may refer to resources selected by other wireless device(s) 22.

FIG. 4 is a flowchart of an example process in a wireless device 22 (e.g., wireless device 22a) according to some embodiments of the present disclosure. One or more Blocks and/or functions performed by wireless device 22 may be performed by one or more elements of wireless device 22 such as by coordination unit 24 in processing circuitry 34, processor 36, radio interface 30, etc. In one or more embodiments, wireless device 22 is configured to determine (Block S104) whether at least one of a plurality of transmission resources associated with a first wireless device 22 (e.g., wireless device 22b) is part of a resource conflict, as described herein. In one or more embodiments, wireless device 22 is configured to cause (Block S106) transmission of resource coordination information that indicates the determination whether the at least one of a plurality of transmission resources associated with the first wireless device 22 is part of the resource conflict, as described herein.

According to one or more embodiments, the processing circuitry 34 is further configured to trigger the transmission of the resource coordination information based at least on sensed information determined by the wireless device 22. According to one or more embodiments, the processing circuitry 34 is further configured to trigger the transmission of the resource coordination information based at least on sensed information received from a second wireless device 22. According to one or more embodiments, the processing circuitry 34 is further configured to trigger the transmission of the resource coordination information based at least on the determination that the resource conflict exists where the resource conflict corresponds to a resource collision of one of the plurality of transmission resources with at least one other transmission resource associated with another wireless device 22 other than the first wireless device 22.

According to one or more embodiments, the processing circuitry 34 is further configured to trigger the transmission of the resource coordination information based at least on a distance between the first wireless device 22 and the wireless device 22. According to one or more embodiments, the resource coordination information includes information received from a second wireless device 22. According to one or more embodiments, the resource coordination information includes a bitmap of resources indicating whether each one of the resources are one of available and unavailable.

According to one or more embodiments, the resource coordination information includes a bitmap of resources that are indicated as one of: for the first wireless device 22 to use; and available for use. According to one or more embodiments, the indication of the determination whether the at least one of the plurality of transmission resources associated with the first wireless device 22 is part of the resource conflict is provided by a one bit field of the resource coordination information. According to one or more embodiments, the indication of the determination whether the at least one of the plurality of transmission resources associated with the first wireless device 22 is part of the resource conflict is provided by sequence.

According to one or more embodiments, the indication of the determination whether the at least one of a plurality of transmission resources associated with the first wireless device 22 is part of the resource conflict is an implicit indication. According to one or more embodiments, the processing circuitry 34 is further configured to receive an enquiry message for requesting resource coordination, the resource coordination information being transmitted at least in response to the enquiry message. According to one or more embodiments, the enquiry message is based at least on one of a detected channel condition, a pre-emption procedure and a Hybrid Automatic Repeat Request, HARQ, procedure.

According to one or more embodiments, the enquiry message is received via a physical layer signaling. According to one or more embodiments, the enquiry message is received via one of a medium access control, MAC, control element, CE, and radio resource control, RRC, message. According to one or more embodiments, the enquiry message indicates at least one of: a preferred format of the resource coordination information; a priority of a transmission on the plurality of transmission resources associated with the enquiry message; a number of subchannels for a transmission on the plurality of transmission resources; and an expected time for receiving the resource coordination information.

According to one or more embodiments, the resource conflict corresponds to at least one predicted collision in reserved resources that include at least the plurality of transmission resources. According to one or more embodiments, the resource conflict corresponds to at least one collision that occurred in resources that include at least the plurality of transmission resources. According to one or more embodiments, the collision corresponds to transmission on the same resources in at least one of time and frequency.

According to one or more embodiments, the collision occurs during half-duplex communications. According to one or more embodiments, the plurality of transmission resources associated with the first wireless device 22 corresponds to resources at least one of resource for transmission and used for transmission. According to one or more embodiments, the resource coordination information is transmitted via one of a medium access control, MAC, control element, CE, radio resource control, RRC, message and physical layer signaling.

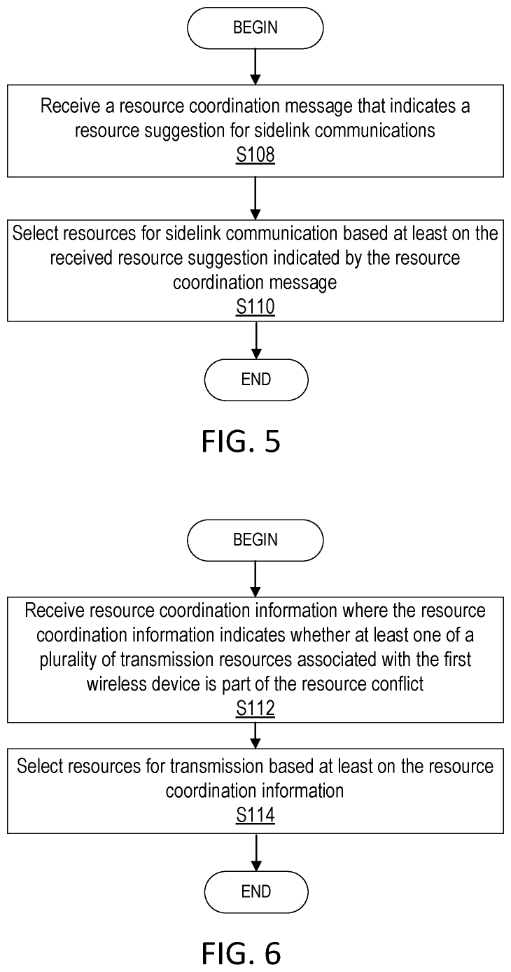

FIG. 5 is a flowchart of an example process in a wireless device 22 (e.g., wireless device 22b) according to some embodiments of the present disclosure. One or more Blocks and/or functions performed by wireless device 22 may be performed by one or more elements of wireless device 22 such as by selection unit 26 in processing circuitry 34, processor 36, radio interface 30, etc. In one or more embodiments, wireless device is configured to receive (Block S108) a resource coordination message that indicates a resource suggestion for sidelink communications, as described herein. In one or more embodiments, wireless device is configured to select (Block S110) resources for sidelink communication based at least on the received resource suggestion indicated by the resource coordination message, as described herein.

According to one or more embodiments, the resource coordination message may be one of a map-based resource coordination message and a one-bit resource coordination message. According to one or more embodiments, the map-based resource coordination message indicates at least one of: a bitmap of resources indicating at least one of scheduled and idle resources; a RSRP mapping; a percentage of collisions; and signals received in a predefined set of resources. According to one or more embodiments, the one-bit resource coordination message indicates one of: to trigger resource (re)-selection; and an acknowledgement and negative acknowledgement. In one or more embodiments, scheduled resources may refer to resources selected by other wireless device(s) 22 or occupied resources.

FIG. 6 is a flowchart of an example process in a wireless device 22 (e.g., wireless device 22b) according to some embodiments of the present disclosure. One or more Blocks and/or functions performed by wireless device 22 may be performed by one or more elements of wireless device 22 such as by selection unit 26 in processing circuitry 34, processor 36, radio interface 30, etc. In one or more embodiments, wireless device 22 is configured to receive (Block S112) a resource coordination information, the resource coordination information indicating whether at least one of a plurality of transmission resources associated with the first wireless device 22 (e.g., wireless device 22b) is part of the resource conflict, as described herein. In one or more embodiments, wireless device 22 is configured to select (Block S114) resources for transmission based at least on the resource coordination information.

According to one or more embodiments, the resource coordination information indicates that the resource conflict exists where the resource conflict corresponds to at least one collision that occurred in resources that include at least the plurality of transmission resources. According to one or more embodiments, the resource information indicates that the resource conflict exists where the resource conflict corresponds to at least one predicted collision in reserved resources that include at least the plurality of transmission resources. According to one or more embodiments, the resource coordination information is based at least on sensed information received from a second wireless device 22.

According to one or more embodiments, the resource coordination information includes a bitmap of resources indicating whether each one of the resources are one of available and unavailable. According to one or more embodiments, the resource coordination information includes a bitmap of resources that are indicated as one of: for the first wireless device 22 to use, and available for use. According to one or more embodiments, the processing circuitry 34 is further configured to: receive additional resource coordination information including an additional bitmap; and determine an updated set of resources resulting from the bitmap and the additional bitmap where the selected resources for transmission is selected based at least on the updated set of resources.

According to one or more embodiments, the updated set of resources corresponds to one of: resources that are indicated as being available in the bitmap and the additional bitmap; resources having a priority level one of equal to and less than a priority level associated with the plurality of transmission resources; and resources associated with at least one more recent timestamp than the remaining resources indicated in the bitmap and additional bitmap. According to one or more embodiments, the indication of whether the at least one of the plurality of transmission resources associated with the first wireless device 22 is part of the resource conflict is provided by a one bit field of the resource coordination information. According to one or more embodiments, the indication of whether the at least one of the plurality of transmission resources associated with the first wireless device 22 is part of the resources conflict is provided by a sequence.

According to one or more embodiments, the indication of whether the at least one of the plurality of transmission resources associated with the first wireless device 22 is part of the resources conflict is an implicit indication. According to one or more embodiments, the selection of resources for transmission is part of a re-selection procedure triggered by the resource coordination information. According to one or more embodiments, the processing circuitry 34 is further configured to transmit an enquiry message for requesting resource coordination where the receiving of the resource coordination information is in response to at least the enquiry message.

According to one or more embodiments, the transmission of the enquiry message is in response to at least on one of a detected channel condition, a pre-emption procedure and a Hybrid Automatic Repeat Request, HARQ, procedure. According to one or more embodiments, the enquiry message is transmitted via a physical layer signaling. According to one or more embodiments, the enquiry message is transmitted via one of a medium access control, MAC, control element, CE, and radio resource control, RRC, message.

According to one or more embodiments, the enquiry message indicates at least one of: a preferred format of the resource coordination information; a priority of a transmission on the plurality of transmission resources associated with the enquiry message; a number of subchannels for a transmission on the plurality of transmission resources; and an expected time for receiving the resource coordination information. According to one or more embodiments, the processing circuitry 34 is further configured to sense information associated with the plurality of transmission resources where the selection of the resources for transmission is further based on the sensed information associated with the plurality of transmission resources. According to one or more embodiments, the processing circuitry 34 is further configured to merge the sensed information associated with the plurality of transmission resources with information included in the resource coordination information.

According to one or more embodiments, the resource conflict corresponds to at least one predicted collision in reserved resources that include at least the plurality of transmission resources. According to one or more embodiments, the resource conflict corresponds to a collision that occurred in resources that include at least the plurality of transmission resources. According to one or more embodiments, the collision corresponds to transmission on the same resources in at least one of time and frequency.

According to one or more embodiments, the collision occurs during half-duplex communications. According to one or more embodiments, the plurality of transmission resources associated with the first wireless device 22 corresponds to resources at least one of resource for transmission and used for transmission. According to one or more embodiments, the resource coordination information is transmitted via one of a medium access control, MAC, control element, CE, radio resource control, RRC, message and physical layer signaling.

Having generally described arrangements for resource selection coordination in sidelink communications, details for these arrangements, functions and processes are provided as follows, and which may be implemented by one or more wireless devices 22. One or more embodiments described below may be performed by one or more of processing circuitry 34, processor 36, radio interface 30, coordination unit 24, selection unit 26, etc.

Embodiments provide for resource selection coordination in sidelink communications. One or more solutions to the problems described in the introduction section are described herein. One or more solutions can respectively address more than one problem and the solutions can be combined in various ways in accordance with the teachings described herein such as any combination of the steps described below. One or more embodiments are described with respect to an example where a pair of wireless devices 22a and 22b, as illustrated in FIG. 5, are involved in the resource coordination framework. However, this framework is equally applicable to examples when more than two wireless devices 22 are involved, using either all or a sub-set of the steps indicated for the case of a pair of wireless devices. One or more embodiments described herein can be used in one or more of unicast connections, groupcast connections, and broadcast connections, although not all steps may be used for each of them. In groupcast and broadcast scenarios, the receiver wireless device 22 can be more than one wireless device 22 and perform the actions as described in relevance for wireless device 22b. Furthermore, the role of the wireless devices 22 (i.e., wireless device 22a and wireless device 22b as described herein) can be reversed without any loss of generality.

In particular, FIG. 5 illustrates two processes (process n and process m, which denote a time n or m when respective Step 1 occurs) that may be performed independent of each other, in the absence of one another and/or may depend on a previous process. The steps 1-4 described below refer to one or more of steps 1-4 from process n and/or process m. In FIG. 5, wireless device 22a is configured with the coordination unit 24 and wireless device 22b is configured with the selection unit 26. For one or more embodiments are described in one or more of the following different steps:

Step 0 (optional step). Configuration: a (pre-)configuration step is performed for performing resource coordination between a pair of wireless devices 22.

Step 1 (optional step). Resource enquiry message: at a time n (or time m), wireless device 22b sends/transmits a resource enquiry message requesting a resource suggestion from wireless device 22a. For example, Step 1 may be performed by selection unit 26 of wireless device 22b.

Step 2. Resource coordination message (e.g., resource coordination information): wireless device 22a sends a resource coordination message carrying the resource suggestion. For example, Step 2 may be performed by coordination unit 24 of wireless device 22a.

Step 3. Wireless device 22b selects resources based at least on the information in the resource coordination message. For example, Step 3 may be performed by selection unit 26 of wireless device 22b.

Step 4. Wireless device 22b transmits using the selected resources from Step 3. For example, Step 4 may be performed by selection unit 26 of wireless device 22b.

Step 0 (Optional): Configuration to Use Resource Coordination Framework

In one or more embodiments for this step, a determination is performed as to whether the wireless device 22 involved in the communication is willing to (i.e., accept to) and/or capable of sending the resource coordination message. The determination is performed based at least on certain criteria such as one or more of battery lifetime, (pre-)configuration by the network node 16, and wireless device capability. For instance, in one example as shown in FIG. 6, wireless device 22b enquires wireless device 22a about its capability and/or interest in using the feature. If wireless device 22a is configured and able to assist the other wireless device 22 by sending a resource coordination message and/or is capable of, wireless device 22a sends the acceptance message. In one or more embodiments, UECapabilityEnquirySidelink and UECapabilitylnformationSidelink as defined in 3GPP TS 38.331 (v16.1.0) can be repurposed and/or modified to provide the enquiry and/or the acceptance. Whereas, in one or more other embodiments, new control signaling (using PC5-RRC message, for example) can be defined. Such signaling exchange may only be possible if there is a unicast (PC5-RRC) connection between wireless devices 22. Note that the enquiry may be started/initiated by any of the wireless devices 22, e.g., as part of connection establishment.

In one or more embodiments, whether the resource coordination framework and respective parameters can be used may be based on (pre-)configuration by the network node 16 (e.g. by gNB or by core network 14 or by configuration stored in SIM), without the need of explicit control signaling exchange over PC5. The (pre-) configuration can be performed per wireless device 22, per resource pool, per bandwidth part or per cell or per carrier.

In one or more embodiments, the configuration of the parameters to be used in the resource coordination framework is part of a predefined specification such as a 3GPP specification.

Some Embodiments Related to the Configuration Step of Step 0

In one or more embodiments, the control message initiated by wireless device 22 (e.g., wireless device 22b) includes a field, e.g., a single bit field, indicating the capability and/or willingness of the wireless device 22 to send a resource coordination message.

In one or more embodiments, upon receiving an enquiry message via PC5-RRC, a wireless device 22 (e.g., wireless device 22a) transmits its acceptance to send the resource coordination message or resource coordination information, e.g., using a bit signaling, as response to the enquiry from the peer wireless device 22. In one or more embodiments, the acceptance to send the resource coordination message is based on certain criteria such as battery lifetime and/or related (pre-)configuration by the network node 16 and/or availability of sensing information (i.e., sensing is enabled) and/or wireless device 22 capability, that may be associated with the wireless device 22 (e.g., wireless device 22a).

In one or more embodiments, the message transmitted by wireless device 22b to wireless device 22a includes elements of configuration (e.g., as described in previous embodiments) together with the resource enquiry message (as described for Step 1 below) such that a single message may be used for Step 0 and Step 1.

Step 1 (Optional): Transmission of the Resource Enquiry Message

In this step, a resource enquiry message is transmitted by wireless device 22b, where the enquiry message is configured to request a resource coordination message from another wireless device 22 (i.e., wireless device 22a).

Embodiments Related to the Triggering Mechanism of Step 1

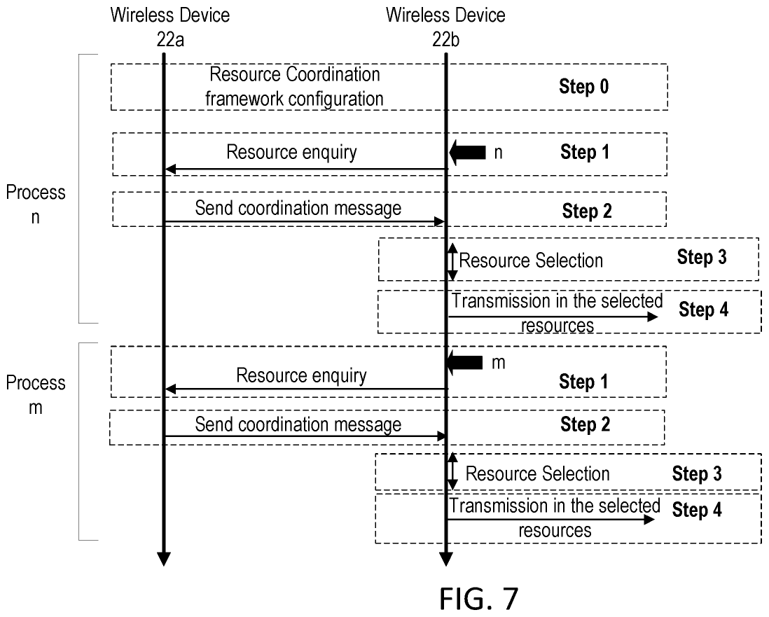

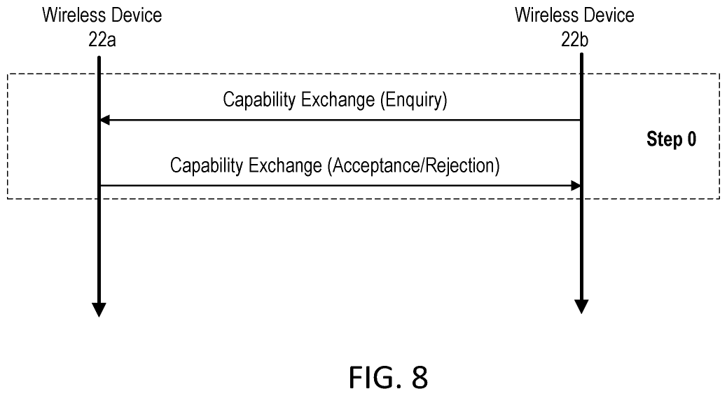

In one or more embodiments, a wireless device 22 (e.g., wireless device 22b) sends a resource enquiry message to a wireless device 22 upon receiving in a transmit buffer a packet from higher layers (i.e., a packet for a future transmission). For example, as illustrated in FIG. 7 at time n or time m.

In one or more embodiments, transmission of the resource enquiry message is triggered upon detecting a condition in the channel. For example, wireless device 22b detects that some resources that it had previously selected for transmission have been reserved by another wireless device 22 for transmission. Wireless device 22b may detect one or more conditions for the triggering by receiving sidelink control information from the other wireless device 22.

In one or more embodiments, transmission of the resource enquiry message is triggered by a pre-emption procedure. For example, wireless device 22b detects that some resources that it had previously reserved for transmission have been reserved by another wireless device 22 for transmission of a high-priority message or a message having a higher priority than the transmission/message that wireless device 22b was going to transmits in the reserved resources. Wireless device 22b may detect this condition by receiving a sidelink control information from the other wireless device 22.

In one or more embodiments, transmission of the resource enquiry message is triggered by the reception of SL HARQ feedback. For example, wireless device 22b receives HARQ-NACK (negative acknowledgement) corresponding to one or more of an earlier transmission, or a number of consecutive HARQ-NACKs, a number of HARQ-NACKs over a period of time, HARQ-NACK for a number of consecutive transmissions of different packets, etc.

In one or more embodiments, transmission of the resource enquiry message is associated with a procedure for reselecting resources corresponding to a periodic selection. For example, wireless device 22b selects a resource for 10 transmissions at times t=k*P (where P is a period and k={1, 2, . . . 10}). After the last transmission, wireless device 22b selects a new resource for 10 further transmissions. In this case, wireless device 22b triggers transmission of the resource enquiry message prior to reselecting resources. In some cases, the reselection or new selection may be determined by a counter. For example, when k=9 or k=10 in the preceding example, wireless device 22b triggers transmission of the resource enquiry message.

In one or more embodiments, a wireless device 22 may be preconfigured to send a resource enquiry message periodically, e.g., after X ms or logical/physical slots.

In one or more embodiments, the implementation of wireless device 22b indicates and/or determines when to trigger the transmission of the resource enquiry message.

In one or more embodiments, a wireless device 22 in power saving mode performs a limited resource allocation procedure, e.g., partial sensing mechanism, and the power saving mode may trigger the resource enquiry message in order to reduce its power consumption and support its resource selection.

In one or more embodiments, whether a wireless device 22 is allowed/mandated by configuration to transmit the resource enquiry message and how often may depend on the congestion of the channel (e.g., as measured in terms of CBR) or the priority of the transmission. For example, the use of resource coordination may be allowed/mandated with low/high congestion. Similarly, the use of resource coordination may be allowed/mandated for high-priority transmissions.

Embodiments Related to the Format and Contents of the Resource Enquiry Message

In one or more embodiments, the resource enquiry message is transmitted using any one of a variety of formats (e.g., the format may correspond to control signaling from protocol layers): for example physical layer signaling (e.g., one bit of sidelink control information and/or transmitted in PSCCH or PSSCH); or in a MAC CE; or in an RRC message.

In case of PHY layer transmission, the enquiry message may be sent in any of the following:
As part of the sidelink control information (SCI) transmitted in PSCCH (i.e., the 1st stage SCI). For this purpose, a reserved bit in the 1st stage SCI (as may be defined in 3GPP Rel-16) may be used. Alternatively, a new first stage SCI may be defined (e.g., differing only in the aforementioned bit).
As part of the sidelink control information (SCI) transmitted in PSSCH (i.e., the 2nd stage of SCI). To this end, a new 2nd stage SCI format may be defined.

In one or more embodiments, the resource enquiry message includes a single bit (i.e., a triggering bit). In another embodiment, the resource enquiry message does not contain a triggering bit but other information that implicitly triggers the transmission of the resource coordination message. In some embodiments, the resource enquiry message includes multiple bits where each bit of the multiple bits may carry different types of information. For example, one or several of the following fields:
Format of the resource coordination message: wireless device 22b may determine its preferred type of suggestion taken from a predefined list (Note: formats are also described in Step 2). In case the format is not signaled, a default or (pre-) configured format is used by wireless device 22a for resource coordination message.
Priority of the selection: signal the priority of the transmission at time n or m, i.e., signal the priority of the transmission that triggered the enquiry. This priority is used by wireless device 22a to select the potential resource(s).
Number of subchannels: required number of subchannels for the transmission at wireless device 22b as indicated by higher layers. The number of subchannels is used by wireless device 22a to select the potential resource(s).
Time to report the resource coordination message: expected time the resource coordination message should arrive at wireless device 22b to be included in the next transmission, i.e., prior to the time instant m-T₃.

Note that the above information may also be used for other purposes than building the resource coordination message. For example, if the enquiry message is transmitted as part of the SCI, some fields of the SCI may be used to obtain the ‘number of sub-channels’ and the ‘priority of the selection’. For example, the SCI fields ‘frequency resource assignment’ and ‘priority’ may be respectively used for that purpose.

In one or more embodiments, these fields of information are not transmitted where the corresponding information is predefined (i.e., part of a 3 GPP specification) or is (pre-)configured. For example, it may be specified that a single sub-channel is to be used when generating the contents of the resource coordination message. Similarly, a (pre-)configured value of priority may be used when generating the contents of the resource coordination message.

Step 2: Transmission of the Resource Coordination Message

After wireless device 22a has received the resource enquiry message, wireless device 22a creates the resource coordination message based on the format/information contained in either the resource enquiry message or pre-defined/pre-configured or its own information (e.g., sensing information).

Additionally, the resource coordination message can be created at wireless device 22a based on (pre-)configuration or its own information (sensing information) without the need of an enquiry message.

Embodiments Related to Signaling of the Resource Coordination Message of Step 2

In one or more embodiments, wireless device 22a sends the resource coordination message (Step 2) based at least on sensing information gathered by wireless device 22a (and/or information forwarded by any other wireless device 22), and is triggered by the reception of resource enquiry message.

In one or more embodiments, the triggering of the resource coordination message is based at least on the sensing information gathered by the wireless device 22 (and/or forwarded by any other wireless device 22) and the detection of one or more collision(s), e.g., wireless device 22a has sensed collisions in the resources selected by wireless device 22b.

In one or more embodiments, the triggering of the resource coordination message is based on the sensing information gathered by the wireless device 22 (and/or forwarded by any other wireless device 22) and is (pre-)configured periodically.

In one or more embodiments, the transmission of the resource coordination message depends on or is based at least on a distance. For example, transmission is triggered only when wireless device 22a is beyond a certain distance from wireless device 22b sending the resource enquiry message. In one case, the location information of wireless device 22b is included in resource enquiry message and in another case, the location information of wireless device 22b is included in another control information such as SCI.

In one or more embodiments, the transmission of the resource coordination message is triggered based at least one on a counter. For example, when a counter reaches a specific value (e.g., 0 or 1), the transmission of the resource coordination message is triggered. This counter may be configured as in or as part of Step 0.

In one or more embodiments, the resource coordination message can be a standalone reporting message or be piggybacked with (i.e., made part of) some other message such as data message.

In one or more embodiments, the resource coordination message can be sent/transmitted using physical layer signaling such as SCI on PSCCH or PSFCH, or higher layer signaling such as MAC CE or PC5 RRC.

In one or more embodiments, the resource coordination message is transmitted using a signal (as opposed to a physical channel). For example, the resource coordination message can be transmitted using a sequence (e.g., a sequence used for the PSFCH). The signal (e.g., sequence) may depend on the transmitter and/or receiver associated with the wireless device 22 (e.g., through an identity or address). The format of the signal and the resources used for transmission may be (pre-) configured or predefined or may be decided during Step 0 and/or Step 1.

In one or more embodiments, the priority of the resource coordination message is either pre-defined or (pre-)configured.

In one or more embodiments, the resource coordination message has a timestamp associated with, for example, time of the sensing or formation of resource coordination message. This timestamp may be used as a time reference for the coordination message (i.e., the timestamp allows wireless device 22b to understand/determine the time of the resources reported in the resource coordination message). For example, the timestamp may be explicitly indicated in the resource coordination message (e.g., using a slot/symbol/frame/subframe index) or may be implicitly derived (e.g., if the resource coordination message is received in slot N, then the time of a resource indicated in the message is relative to slot N-K). The explicit indication may be used in combination with higher layer signaling (e.g., MAC CE, RRC) and/or the implicit derivation may be used for PHY signaling.

In one or more embodiments, the resource coordination message can either be map-based or one-bit message. The use of either map-based or one-bit resource coordination message may be (pre-)configured (e.g., using some of the options in Step 0).

Embodiments Related to Map-Based Resource Coordination Message

In one or more embodiments, the map-based resource coordination message can have any of the following information:
Bitmap of resources indicating busy/idle resources: The wireless device 22a sends/transmits to one or more wireless device(s) such as wireless device 22b the bitmap of resources by labelling them as busy/not-available or idle/available (e.g., with one bit). Whereas the resources are determined to be idle/available or busy/not-available by wireless device 22a by comparing the received signal power (e.g., SL RSRP, SL received signal strength indicator (RSSI)) with a threshold. The threshold may be (pre-)configured in Step 0 or predefined.
RSRP mapping: Similar to the bitmap of resources but instead of a busy or idle indication, the received power measurement SL-RSRP is signaled by wireless device 22a.
Percentage of collisions: A field associated to/with a resource, e.g., two bits (4 levels) to indicate the level of collisions (e.g., low, medium, high, very high) which are mapped to a percentage of collisions. This information is used at wireless device 22b to trigger (re-)selection of resources.
Received (RX) signals a specific set of resources: Only a specific (set of) resource(s) is (are) signaled which is (are) considered to be the best resource candidate from wireless device 22a perspective.

In one or more embodiments, the definition of a resource is determined by a certain number of subchannels/resource blocks. In one example, the resource is equal to one subchannel and in another example the resource is equal to a number of subchannels. In one example, the subchannel is used as a basic scheduling unit in frequency domain.

In one or more embodiments, in the case that the resource enquiry message (e.g., 1 bit signal) is transmitted by wireless device 22b in either a first stage SCI or second stage SCI, the number of subchannels used to determine the size/definition of a resource may be the one indicated in the SCI itself, i.e., resource allocation of transmission by wireless device 22a indicated in SCI.

In one or more embodiments, the number of subchannels used to determine the size/definition of a resource are (pre-)configured or pre-defined (e.g., as in or during Step 0).

In one or more embodiments, the priority used to select or determine the availability of the resource(s), i.e., priority used to define the SL-RSRP threshold by wireless device 22a, is determined by the priority value indicated by wireless device 22b in case of enquiry-based framework. In one example, in the case that the resource enquiry message (e.g., 1 bit signal) is transmitted by wireless device 22b in either first stage SCI or second stage SCI, the priority value used to define SL-RSRP threshold by wireless device 22a is the one received in SCI, i.e., the priority indicated in the first stage SCI by wireless device 22b.

In one or more embodiments, the priority used to select or determine the availability of the resource(s) by wireless device 22a is signaled in the resource coordination message.

In one or more embodiments, the priority used to select or determine the availability of the resource(s) by wireless device 22a is (pre-)configured or pre-defined (e.g., as in or during Step 0).

In one or more embodiments, the resource coordination message includes information received from another wireless device 22. For example, wireless device 22a builds its resource coordination message using information that is in turn received in a resource coordination message received from wireless device 22c.

In one or more embodiments, wireless device 22a considers the resources indicated in the resource coordination message as unavailable for its own transmissions. That is, since wireless device 22a suggests those resources as part of resource coordination, wireless device 22a commits to not transmitting on those resources. To this end, the resources are considered as unavailable by sensing or non-selectable in resource selection.

Embodiments Related to One-Bit Resource Coordination Message

In one or more embodiments, a one-bit resource coordination message can have any of the following formats/types:
In case of a non-enquiry-based model, wireless device 22a senses the resource(s) reserved by the wireless device 22b and determines if there are collisions in the reserved resource(s). Wireless device 22a sends a one-bit message, so the wireless device 22b triggers its resource (re-)selection mechanism.
In case of an enquiry-based model, a one-bit resource coordination message may include an acknowledgement from wireless device 22a based on its own sensing information and received information on the selected/reserved resource(s) by wireless device 22b. In case wireless device 22a detects the collision, wireless device 22a sends the negative acknowledgement from which wireless device 22b can trigger its resource (re-)selection.

In one or more embodiments, for the transmission of a one-bit based resource coordination message using physical layer signaling, a sequence-based channel may be used. In one example, an existing sequence-based channel such as PSFCH is used (i.e., one code is defined for a resource coordination message) or a new sequence-based channel is defined.

Step 3: Resource Selection Upon Receiving the Resource Coordination Message

In this step, wireless device 22b receives the resource coordination message from wireless device 22a, and wireless device 22b uses the suggestion indicated by the resource coordination message as support to decide its own new (set of) resource(s) for transmission(s).

Embodiments Related to Step 3

In one or more embodiments, a wireless device 22b performs resource selection considering the information in the received map-based resource coordination message as defined in Step 2. For example, wireless device 22b may merge the results from sensing (obtained by itself) with the information in the resource coordination message. For example, a resource may be deemed as unavailable if the resource is deemed as unavailable by either sensing or the resource coordination message. Similarly, the RSRP value associated with a resource may be a function (e.g., max, average, weighted average, etc.) of the different contributions (sensing and resource coordination message).

In one or more embodiments, wireless device 22b, upon receiving a one-bit based resource coordination message as defined in Step 2, triggers a resource re-selection procedure.

In one or more embodiments, if wireless device 22b receives several map-based resource coordination messages before its decision to select a set of resources for transmission, one or more of the following steps to select/determine the most trustworthy set of resources may be implemented:
Wireless device 22b may create a set of resources with the set of resources resulting from the intersection of the different sets, i.e., the resources which are indicated as free by several coordination messages.
Another action is to choose the set of resources with the same priority as its own transmission or to choose the resources which have been selected based on a more restrictive priority (i.e., lower priority) than the one for its own transmission to ensure a potentially higher reliability.
Using the value from the timestamp if there are conflicting set of resources from the coordination messages those with a more recent timestamp prevail over the others.

In one or more embodiments, wireless device 22b combines resource coordination messages from multiple sources in any of the ways described above (e.g., intersection, RSRP-function, etc.)

Step 4: Transmission Using the Selected Resource(s)

The wireless device 22 receiving the resource coordination message (i.e., wireless device 22b) transmits in the selected resources which is either based on new resource selection considering the resource coordination message and/or based on its previous resource selection.

Embodiment Related to Step 4

In one or more embodiments, the selected resources can be the ones selected from one or more of the following:
based on its own previous resource selection, i.e., without taking into consideration the resource coordination message; or
based on the resources indicated in the resource coordination message (or partially indicated in the coordination messages, i.e., a sub-set of the indicated resources) in case of map-based resource coordination message; or
the resources selected after triggering resource (re-)selection upon receiving a one-bit based resource coordination message.

### SOME EXAMPLES

In the following, two examples are described using the scenario as defined in FIG. 7

### Example 1: Map-Based Resource Coordination Message

In this example, the coordination framework is based on Step 0, Step 1, Step 2, Step 3 and Step 4.

The resource coordination framework is enabled as a part of resource pool (pre-) configuration (Step 0).

Upon receiving signaling from the higher layer to perform a transmission, wireless device 22b triggers the resource enquiry message (Step 1). In this enquiry message, it is requested to have as a response a coordination message in the form of a bitmap of resource, i.e., idle/busy resources, the priority of the transmission that has triggered the enquiry message and the number of subchannels needed for that transmission.

Upon receiving the resource enquiry message, wireless device 22a uses the information included in the resource enquiry message to create the resource coordination message, i.e., to create the map of resources to be sent/transmitted by wireless device 22a as a support for wireless device 22b selection. Once the map of resources is created, wireless device 22a sends the resource coordination message to wireless device 22b (Step 2).

Once wireless device 22b receives the resource coordination message, wireless device 22b uses this information to support its own resource selection (Step 3) and once the decision is performed, i.e., which resources to use for transmission have been, wireless device 22b uses the selected resources to perform the transmission that has triggered the resource enquiry message (Step 4).

Note that in this example, one or more of Step 0 and Step 1 may be omitted. The transmission of the message by wireless device 22b could be determined by some other condition than the reception of an enquiry message.

### Example 2: One-Bit Based Resource Coordination Message

In this example, the coordination framework includes Step 2, Step 3 and Step 4.

Since wireless device 22a and wireless device 22b are within each other's range, it is possible for both to sense the resource selected/reserved by each other by means of the sidelink control channel, i.e., sensing the SCI. In this example, wireless device 22a senses that the resources selected/reserved by wireless device 22b for transmission are in conflict with either its own or some other wireless device 22's selected/reserved resources. This collision information triggers the resource coordination message from wireless device 22a (Step 2).

In this case, the resource coordination message may be formed by a one-bit signal which can be signaled using physical layer control signaling such as PSFCH or higher layer signaling like MAC CE.

Upon receiving this one-bit signal from wireless device 22a that indicates to wireless device 22b that a re-selection of the resources previously selected for transmission may be performed, wireless device 22b may perform the re-selection of the resources for transmission (Step 3). Once the new resources are selected, the data is transmitted using these resources (Step 4).

Some Other Examples:

Example A1. A wireless device 22, the wireless device 22 configured to, and/or comprising a radio interface 30 and/or comprising processing circuitry 34 configured to:

cause transmission of a resource coordination message that indicates a resource suggestion for sidelink communications; and

optionally receive an indication of resources selected by another wireless device 22.

Example A2. The wireless device 22 of Example A1, wherein the resource coordination message is one of a map-based resource coordination message and a one-bit resource coordination message.

Example A3. The wireless device 22 of Example A2, wherein the map-based resource coordination message indicates at least one of:
a bitmap of resources indicating at least one of scheduled and idle resources;
a RSRP mapping;
a percentage of collisions; and
signals received in a predefined set of resources.

Example A4. The wireless device 22 of Example A2, wherein the one-bit resource coordination message indicates one of:
to trigger resource selection; and
an acknowledgement and negative acknowledgement.

Example B1. A method implemented in a wireless device 22, the method comprising:
causing transmission of a resource coordination message that indicates a resource suggestion for sidelink communications; and
optionally receiving an indication of resources selected by another wireless device 22.

Example B2. The method of Example B1, wherein the resource coordination message is one of a map-based resource coordination message and a one-bit resource coordination message.

Example B3. The method of Example B2, wherein the map-based resource coordination message indicates at least one of:
a bitmap of resources indicating at least one of scheduled and idle resources;
a RSRP mapping;
a percentage of collisions; and
signals received in a predefined set of resources.

Example B4. The method of Example B2, wherein the one-bit resource coordination message indicates one of:
to trigger resource selection; and
an acknowledgement and negative acknowledgement.

Example C1. A wireless device 22 configured to, and/or comprising a radio interface 30 and/or processing circuitry 34 configured to:
receive a resource coordination message that indicates a resource suggestion for sidelink communications; and
select resources for sidelink communication based at least on the received resource suggestion indicated by the resource coordination message.

Example C2. The wireless device 22 of Example C1, wherein the resource coordination message is one of a map-based resource coordination message and a one-bit resource coordination message.

Example C3. The wireless device 22 of Example C2, wherein the map-based resource coordination message indicates at least one of:
a bitmap of resources indicating at least one of scheduled and idle resources;
a RSRP mapping;
a percentage of collisions; and
signals received in a predefined set of resources.

Example C4. The wireless device 22 of C2, wherein the one-bit resource coordination message indicates one of:
to trigger resource selection; and
an acknowledgement and negative acknowledgement.

Example D1. A method implemented in a wireless device 22, the method comprising:
receiving a resource coordination message that indicates a resource suggestion for sidelink communications; and
selecting resources for sidelink communication based at least on the received resource suggestion indicated by the resource coordination message

Example D2. The method of Example D1, wherein the resource coordination message is one of a map-based resource coordination message and a one-bit resource coordination message.

Example D3. The method of Example D2, wherein the map-based resource coordination message indicates at least one of:
a bitmap of resources indicating at least one of scheduled and idle resources;
a RSRP mapping;
a percentage of collisions; and
signals received in a predefined set of resources.

Example D4. The method of Example D2, wherein the one-bit resource coordination message indicates one of:
to trigger resource selection; and
an acknowledgement and negative acknowledgement.

Therefore, a framework is provided herein to coordinate the resource selection mechanism based on information sent, e.g., map-based or single-bit based resource coordination message, from one or more other wireless device(s) is defined. The mechanism can be triggered based at least on a resource enquiry message sent from the wireless device 22 requesting to receive the resource coordination message.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
Abbreviation Explanation
ACK Acknowledgement
CE Control Element
HARQ Hybrid Automatic Response Request
MAC Medium Access Control
NACK Negative ACK
PHY Physical
PSCCH Physical Sidelink Control Channel
PSSCH Physical Sidelink Shared Channel
PSFCH Physical Sidelink Feedback Channel
RRC Radio Resource Control
SCI Sidelink Control Information
SIM Subscriber Identity Module
SL Sidelink
UE User Equipment
RSRP Reference signal received power
RSSI Received Signal Strength Indicator

It will be appreciated by persons skilled in the art that the embodiments described herein are not limited to what has been particularly shown and described herein above. In addition, unless mention was made above to the contrary, it should be noted that all of the accompanying drawings are not to scale A variety of modifications and variations are possible in light of the above teachings without departing from the scope of the following claims.

1. A wireless device comprising:
processing circuitry configured to:
determine whether at least one of a plurality of transmission resources associated with a first wireless device is part of a resource conflict; and
cause transmission of resource coordination information that indicates the determination whether the at least one of the plurality of transmission resources associated with the first wireless device is part of the resource conflict.

2. The wireless device of claim 1, wherein the processing circuitry is further configured to trigger the transmission of the resource coordination information based at least on sensed information determined by the wireless device.

3. The wireless device of claim 1, wherein the processing circuitry is further configured to trigger the transmission of the resource coordination information based at least on sensed information received from a second wireless device.

4. The wireless device of claim 1, wherein the processing circuitry is further configured to trigger the transmission of the resource coordination information based at least on the determination that the resource conflict exists, the resource conflict corresponding to a resource collision of one of the plurality of transmission resources with at least one other transmission resource associated with another wireless device other than the first wireless device.

5. The wireless device of claim 1, wherein the processing circuitry is further configured to trigger the transmission of the resource coordination information based at least on a distance between the first wireless device and the wireless device.

6. The wireless device of claim 1, wherein the resource coordination information includes information received from a second wireless device.

7. The wireless device of claim 1, wherein the resource coordination information includes a bitmap of resources indicating whether each one of the resources are one of available and unavailable.

8. The wireless device of claim 1, wherein the resource coordination information includes a bitmap of resources that are indicated as one of:
for the first wireless device to use; and
available for use.

9. The wireless device of claim 1, wherein the indication of the determination whether the at least one of the plurality of transmission resources associated with the first wireless device is part of the resource conflict is provided by a one bit field of the resource coordination information.

10. The wireless device of claim 1, wherein the indication of the determination whether the at least one of the plurality of transmission resources associated with the first wireless device is part of the resource conflict is provided by sequence.

11-22. (canceled)

23. A first wireless device comprising:
processing circuitry configured to:
receive a resource coordination information, the resource coordination information indicating whether at least one of a plurality of transmission resources associated with the first wireless device is part of the resource conflict; and
select resources for transmission based at least on the resource coordination information.

24. The first wireless device of claim 23, wherein the resource coordination information indicates that the resource conflict exists, the resource conflict corresponding to at least one collision that occurred in resources that include at least the plurality of transmission resources.

25. The first wireless device of claim 23, wherein the resource information indicates that the resource conflict exists, the resource conflict corresponding to at least one predicted collision in reserved resources that include at least the plurality of transmission resources.

26. The first wireless device of claim 23, wherein the resource coordination information is based at least on sensed information received from a second wireless device.

27. The first wireless device of claim 23, wherein the resource coordination information includes a bitmap of resources indicating whether each one of the resources are one of available and unavailable.

28. The first wireless device of claim 23, wherein the resource coordination information includes a bitmap of resources that are indicated as one of:
for the first wireless device to use; and
available for use.

29. The first wireless device of claim 23, wherein the processing circuitry is further configured to:
receive additional resource coordination information including an additional bitmap; and
determine an updated set of resources resulting from the bitmap and the additional bitmap, the selected resources for transmission being selected based at least on the updated set of resources.

30. The first wireless device of claim 29, wherein the updated set of resources corresponds to one of:
resources that are indicated as being available in the bitmap and the additional bitmap;
resources having a priority level one of equal to and less than a priority level associated with the plurality of transmission resources;
resources associated with at least one more recent timestamp than the remaining resources indicated in the bitmap and additional bitmap.

31. The first wireless device of claim 23, wherein the indication of whether the at least one of the plurality of transmission resources associated with the first wireless device is part of the resource conflict is provided by a one bit field of the resource coordination information.

32. The first wireless device of claim 23, wherein the indication of whether the at least one of the plurality of transmission resources associated with the first wireless device is part of the resources conflict is provided by a sequence.

33-94. (canceled)
